(19) United States
(12) Patent Application Publication
(10) Pub. No.: US 2023/0017729 A1
(43) Pub. Date: Jan. 19, 2023

(54) COMPACT ETALON STRUCTURE

(71) Applicant: Lumentum Operations LLC, San Jose, CA (US)

(72) Inventor: Adrian Perrin JANSSEN, Exeter (GB)

(21) Appl. No.: 17/648,767

(22) Filed: Jan. 24, 2022

Related U.S. Application Data
(60) Provisional application No. 63/203,271, filed on Jul. 15, 2021.

(51) Int. Cl. G02B 5/28; G02B 17/00

(52) U.S. Cl. CPC G02B 5/284; G02B 17/004; G02B 17/006; G02B 5/04

(57) ABSTRACT

An etalon may include a plurality of reflectors, wherein at least one reflector, of the plurality of reflectors, is partially reflecting of light in a frequency range and each other reflector, of the plurality of reflectors is either partially or fully reflecting of light in the frequency range, and wherein the plurality of reflectors comprises at least three reflectors arranged to define a volume of a resonant optical cavity.

### CROSS-REFERENCE TO RELATED APPLICATION

This patent application claims priority to U.S. Provisional Patent Application No. 63/203,271, filed on Jul. 15, 2021, and entitled “COMPACT ETALON STRUCTURE.” The disclosure of the prior application is considered part of and is incorporated by reference into this patent application.

### TECHNICAL FIELD

The present invention relates to optical etalons and to a compact etalon structure.

### BACKGROUND

An optical etalon is an optical cavity made from two parallel reflecting surfaces (e.g., thin mirrors). The fraction of optical power that can be transmitted through the etalon depends on the degree of resonance between the wavelength and the distance between the mirrors. Etalons are widely used in telecommunications, lasers, and spectroscopy to control and measure the wavelengths of light.

FIG. 1 is a schematic diagram of a Fabry-Perot etalon 100. Such an etalon comprises a pair of partially reflective surfaces 101, 102 spaced apart from each other, the space between the surfaces forming a cavity 103. Such spacing may range from micrometers to centimeters. The spectral response of an etalon is based on interference between light launched into it and light circulating in the cavity.

The arrangement enables an incident light beam 104 to be multiply reflected 105 between the reflective surfaces 101, 102. The exiting beams 106 are focused by a lens 107.

For an ideally collimated optical beam, the multiple reflections within the cavity result in a power transmission given by:

$$T = \frac{( 1 - {R}_{1} ) ( 1 - {R}_{2} )}{[ 1 - {( {R}_{1} {R}_{2} )}^{1 / 2} ] + 4 {( {R}_{1} {R}_{2} )}^{1 / 2} {sin}^{2} Φ} \qquad Equation 1$$

wherein R₁ is the power reflectivity of the first mirror (surface 101), R₂ is the power reflectivity of the second mirror (surface 102), and Φ is the phase shift which occurs in one transmission of the etalon. Φ is given by:

$$Φ = \frac{2 π {L}^{′} v}{c} \qquad Equation 2$$

wherein c is the speed of light in a vacuum, ν is the frequency of the incident light and L′ is given by Equation 3:

L′=nᵣL cos θ Equation 3:

wherein L is the distance separating the first mirror and the second mirror, nᵣ is the refractive index of the material in the cavity, and θ is the angle of incidence 108.

An important parameter for etalons is the spacing in frequency between peaks, known as the free spectral range (FSR), Δν_{fsr}. This is given by equation 4:

$$Δ {v}_{fsr} = \frac{c}{2 {L}^{′}} \qquad Equation 4$$

The FSR thus corresponds to the cavity width. It is possible to design etalon lockers with a Free Spectral Range of 100 gigahertz (GHz). For a fixed channel spacing of 50 GHz (according to the International Telecommunications Union (ITU) grid) and for gridless lockers the FSR can be smaller. The FSR corresponds to the cavity width of the etalon which, for a silica or glass etalon, will be about 1 millimeter (mm) width. This provides a lower dimension limit for etalons. The saving of space, however, in optical devices means that it is desirable to have as small a footprint as possible for optical components. For etalons, however, this is limited by the required FSR.

### SUMMARY

According to an aspect of the invention, there is provided an etalon comprising a plurality of reflectors, wherein at least one reflector is partially reflecting of light in a required frequency range and each of the other surfaces is either partially or fully reflecting of light in the required frequency range. The plurality of reflectors comprises at least three reflectors and are arranged to define a volume of a resonant optical cavity.

In an embodiment, the plurality of reflectors consists of a plurality of pairs of parallel reflectors.

In an embodiment, the etalon consists of a first pair of parallel reflectors and a second pair of parallel reflectors. The first pair of reflectors consists of a first reflector and a second reflector, and the second pair of reflectors consists of a third reflector and a fourth reflector. The first reflector and the third reflector are disposed adjacent each other and at an angle to each other, and the second reflector and fourth reflector are disposed adjacent each other and at the same angle to each other.

In an embodiment, the etalon comprises a hexagonal prism, and wherein the first reflector, the second reflector, the third reflector and the fourth reflectors are disposed on sides of the prism, and the prism further comprises a fifth reflector and a sixth reflector, wherein the fifth reflector is disposed on a side of the prism between the first reflector and the fourth reflector, and the sixth reflector is disposed between the third reflector and the second reflector.

In an embodiment, each reflector has a respective first edge and a respective second edge parallel to the respective first edge, the respective first edges of the first and third reflectors being adjacent each other and respective first edges of the second and fourth reflectors being adjacent each other, the etalon further comprising a first gap between the second edge of the first reflector and the second edge of the fourth reflector, and a second gap between the second edge of the second reflector and the second edge of the third reflector, wherein the gaps are of a same length determined by a required light path length.

In an embodiment, the fifth reflector is disposed in the first gap and the second reflector is disposed in the second gap.

In an embodiment, the plurality of reflectors consists of pairs of parallel reflectors and the pairs of parallel reflectors are arranged to define a regular polygon with 2n sides, wherein n is an integer greater than 1.

In an embodiment, the first reflector and the second reflector are of a first length, the third reflector and the fourth reflector are of a second length, the first length being longer than the second length, the first length being determined so as to allow multiple reflections between the first reflector and the second of light incident perpendicular to the third reflector.

In an embodiment, one reflector is partially reflecting and each of the other reflectors is fully reflecting.

In an embodiment, two reflectors are partially reflecting and each of the other reflectors is fully reflecting.

In an embodiment, the third reflector is partially reflecting and the first, second, and fourth reflectors are fully reflecting.

In an embodiment, the third reflector and the fourth reflector are partially reflecting and the first reflector and second reflector are fully reflecting.

In an embodiment, the second reflector and the third reflector are partially reflecting and the first, fourth and fifth reflectors are fully reflecting.

In an embodiment, the third reflector and the fourth reflectors are partially reflecting and the first, second, fifth, and sixth reflectors are fully reflecting.

In an embodiment, the one or more partially reflecting surfaces has a reflectivity in a range of 10% to 99% at 1550 nanometers (nm).

In an embodiment, the reflectors are arranged perpendicular to an x-y plane and are arranged to form a resonant optical cavity for light transmitted in the x-y plane.

In an embodiment, the reflectors are tilted at an angle to the direction of the incident light.

In an embodiment, there is provided a bidirectional filter comprising an etalon according to the first aspect.

In an embodiment, an etalon may include a plurality of reflectors, wherein at least one reflector, of the plurality of reflectors, is partially reflecting of light in a frequency range and each other reflector, of the plurality of reflectors, is either partially or fully reflecting of light in the frequency range, and wherein the plurality of reflectors comprises at least three reflectors arranged to define a volume of a resonant optical cavity.

In an embodiment, a bidirectional filter may include an etalon, which may include plurality of reflectors, wherein at least one reflector, of the plurality of reflectors, is partially reflecting of light in a frequency range and each other reflector, of the plurality of reflectors is either partially or fully reflecting of light in the frequency range, and wherein the plurality of reflectors comprises at least three reflectors arranged to define a volume of a resonant optical cavity.

In an embodiment, an etalon may include a plurality of reflectors, wherein a first set of reflectors, of the plurality of reflectors, is partially reflecting of light in a frequency range and a second set of reflectors, of the plurality of reflectors, is fully reflecting of light in the frequency range, and wherein the plurality of reflectors comprises an even quantity of reflectors arranged to define a volume of a resonant optical cavity.

### BRIEF DESCRIPTION OF THE DRAWINGS

FIG. 1 is a schematic diagram of a conventional Fabry-Perot etalon;

FIG. 2 (a) is a schematic view of the arrangement of FIG. 1 viewed in a direction perpendicular to the view of FIG. 1 and perpendicular to the direction of the propagation of light when the etalon is in use;

FIG. 2 (b) is a schematic view showing tilted etalon reflectors;

FIG. 3 (a) is a schematic diagram of an etalon with three reflectors according to an embodiment;

FIG. 3 (b) is a perspective diagram of the embodiment of FIG. 3 (a);

FIG. 3 (c) is a perspective diagram of the embodiment;

FIGS. 4 (a)-(c) are schematic diagrams of embodiments with odd numbers of reflectors;

FIG. 5 (a) is a schematic view of an etalon with four reflectors according to an embodiment;

FIG. 5 (b) is a perspective view of an etalon with four reflectors according to an embodiment;

FIG. 5 (c) is a side view of an etalon with four reflectors according to the embodiment of FIG. 5 (b);

FIG. 5 (d) is a perspective view of an etalon with four reflectors according to an embodiment;

FIG. 5 (e) is a perspective view of an etalon with four reflectors according to an embodiment;

FIG. 6 is a schematic illustration of the embodiment of FIG. 5 showing possible light paths through the resonant cavity of the etalon;

FIG. 7 is a schematic illustration of an etalon with four reflectors implemented using a prism according to an embodiment;

FIG. 8 is a schematic diagram an etalon with four reflectors, which illustrates an arrangement of partially reflecting and fully reflecting surfaces;

FIG. 9 is a schematic diagram of an etalon with four reflectors, which illustrates an alternative arrangement of partially reflecting and fully reflecting surfaces;

FIG. 10 is a graph showing optical simulation results obtained for power transmission against wavelength for an etalon according to the embodiment of FIG. 7;

FIG. 11 is a schematic diagram of an etalon with six reflectors according to an embodiment;

FIG. 12 is a schematic diagram of an etalon with eight reflectors according to an embodiment;

FIG. 13 is a schematic diagram of an etalon with four reflectors, in a folded beam configuration, according to an embodiment;

FIG. 14 is a graph showing results obtained for power transmission against wavelength for an etalon according to the embodiment of FIG. 13;

FIG. 15 is a schematic diagram of the embodiment of FIG. 13, illustrating multiple beams incident on the etalon;

FIG. 16 is a graph showing results obtained for power transmission against wavelength for an etalon according to the embodiment of FIG. 15;

FIG. 17 is a schematic diagram of an etalon according to an embodiment used as a bidirectional filter; and

FIG. 18 is a schematic diagram of an etalon according to another embodiment used as a bidirectional filter.

### DETAILED DESCRIPTION

The present invention seeks to address the problem of how to reduce the lower dimension limit for etalons designed for a given free spectral range (FSR). This reduction has the advantage of reducing the volume required for components. Alternatively, a smaller free spectral range can be achieved for an etalon of the same size. An advantage of designing an etalon having a smaller Free Spectral Range relative to size is that such a design allows frequency determination with a higher precision. Given a noise floor and fixed detection sensitivity, the frequency precision (Δf) is proportional to the FSR. As discussed above, for a conventional single parallel sided etalon, the FSR is inversely proportional to the thickness of the etalon. This is a distinct disadvantage in designing increasingly compact laser components for high speed fiber optics and has been a design limiting factor. The present invention, which may be referred to as a cross-over etalon, in embodiments, allows the FSR to be reduced by a factor of at least two with no increase in size. As a result, there may be a direct advantage of frequency precision by a factor of two under the same conditions.

A further advantage over other etalons is that the beam reflected back from the etalon is not reflected into the source as the beam does not follow the path of the incident beam but is reflected back at a large angle. Back reflection is a problem for systems using other etalon designs, such as if a large reflected power is fed back to a laser source, for example. In embodiments of the present invention, the position and the angle of the output beam and reflected beams are different, reducing this problem.

These aims are achieved by departing from the conventional parallel sided block used commonly to make an etalon. In this way, it is possible to obtain an etalon optical resonator with dimensions smaller than those limited by the FSR of a conventional etalon. The present invention provides a reduction in the size of an etalon by increasing the number of reflective surfaces and hence the number of internal reflections of the light beam within the cavity. The solutions provided by the present invention also exhibit the property that the reflected beam is tilted away from the incoming beam under all angles of incidence and this has benefits for reducing the effects of multiple reflections into the etalon and increasing the precision with which the etalon can be calibrated.

The present invention provides an etalon which provides at least three reflectors, wherein a reflector includes to a reflective surface in the etalon, which is either partially reflective or fully reflective for electromagnetic radiation in a required wavelength range. The term “light” may refer to electromagnetic radiation and is not restricted to visible light, but covers also infrared radiation used in optical fiber systems as well as other frequencies of electromagnetic radiation. An example range of wavelengths can be the whole or part of one or more of the ITU C-band (1530 nm to 1565 nm), S-band (1460 nm to 1530 nm), and L-band (1565 nm to 1625 nm). However, the invention is not limited to these ranges, and may be configured for other wavelengths, such as, but not limited to the E-band (1360 nm to 1460 nm), the O-band (1260 nm to 1360 nm) and the 850 nm band. The term fully “reflecting surface” is used to mean that the reflectivity from the surface of light of the wavelength range is 100% of light not absorbed by the surface. The term “partially reflecting” is used to mean that light in the required wavelength range is partly reflected from and partly transmitted by the surface. A reflector is a surface within the etalon that, when the etalon is in use, reflects a beam of light incident on the etalon once during a single traversal of the etalon by the beam. A reflector thus contributes to the resonance of the incident light. In some embodiments, the reflector is planar. The term reflector does not include other surfaces, which may be a part of the etalon, but do not contribute to the resonance of the light. In other words, a reflector is a fully or partially reflective surface which is in the light path within the etalon, when the etalon is in use. A reflector may be a mirror or a reflective or partially reflective surface on a prism. An etalon comprising mirrors and air gaps may be referred to as an “air gap etalon.” An etalon comprising a prism may be referred to as a “solid etalon.”

In some embodiments, more than three reflective surfaces are provided. As described herein, even numbers of reflective surfaces are preferable. For example, four or six reflective surfaces are provided, but the invention is not limited to these numbers, and other numbers of reflectors may be used.

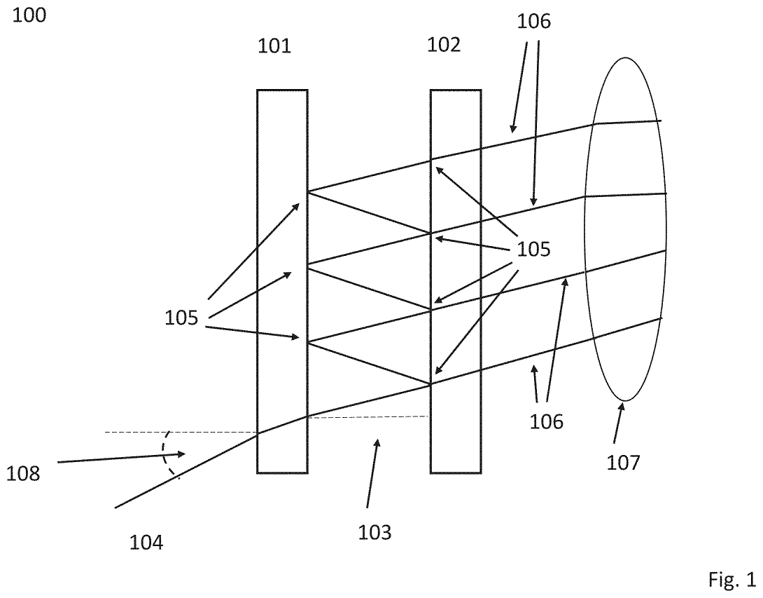

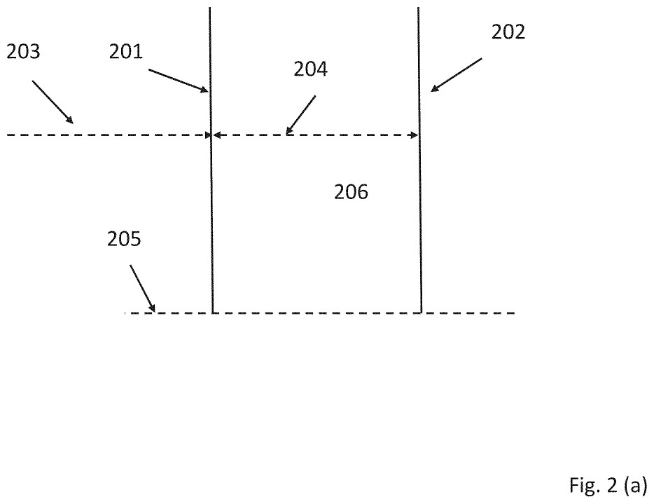

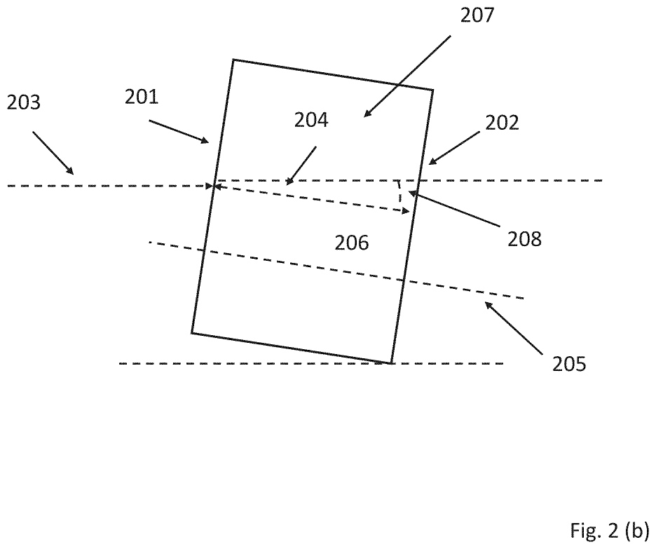

In some embodiments, in order to form a resonant cavity, the reflectors are disposed perpendicular to a conceptual plane, which may be referred to as a “first plane,” an “x-y plane,” or a “horizontal plane.” A direction perpendicular to this plane may be referred to as being “vertical.” The surfaces surround a volume of a resonant cavity, in which multiple reflections occur, when the etalon is in use. FIG. 2 is a schematic view of the arrangement of FIG. 1 viewed in a direction perpendicular to the view of FIG. 1 and perpendicular to the direction of the propagation of light when the etalon is in use. The view shows two reflectors 201, 202 of the etalon, which are equivalent to the reflecting surfaces 101, 102 of FIG. 1. In use, incident light 203 enters the etalon and resonates 204 between the reflectors. The reflectors are perpendicular to the conceptual plane 205, and define a volume of the resonant cavity 206. The resonant cavity is the volume in which, when the etalon is in use, the light multiply reflects between the reflectors. In the present invention, similar structures are provided, but with more than two reflectors defining the resonant cavity. The reflectors are perpendicular to the conceptual x-y plane and are arranged to define a resonant cavity. In the example in FIG. 2a, the incident light is transmitted in a plane parallel to the conceptual x-y plane and enters the etalon perpendicular to the reflectors. In embodiments of the invention, this may also be the case. FIG. 2(b) illustrates an alternative arrangement, with the etalon implemented as a prism, in which the incident light enters the etalon at a non-perpendicular angle to the reflectors. In the example of FIG. 2(b), the prism 207 provides a first (201) and a second (202) reflecting surface or reflector. The incident light 203 enters the prism at an angle 208 to the conceptual plane 205 and resonates 204 in the resonant cavity 206.

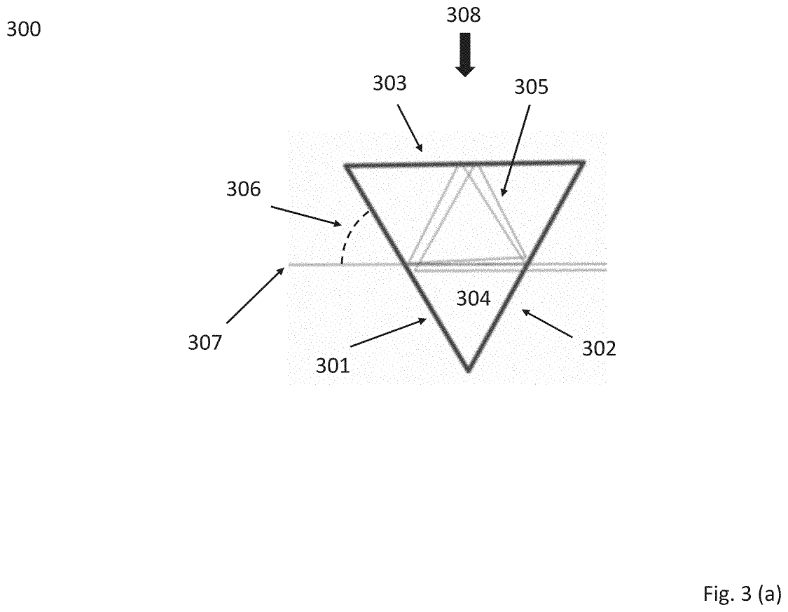

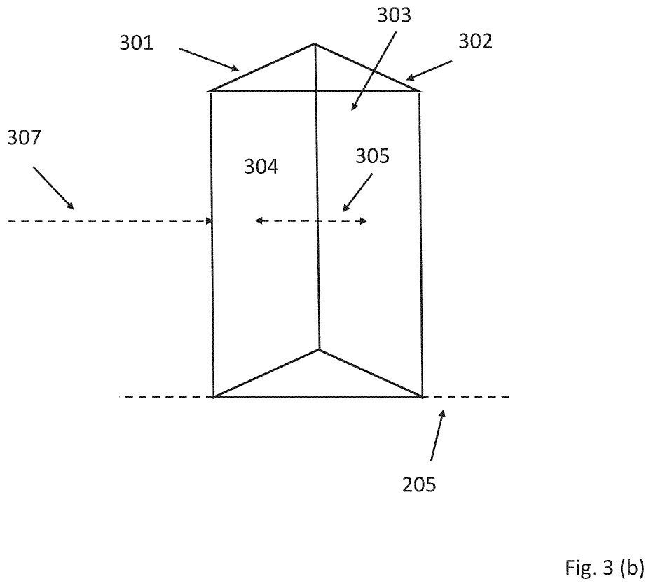

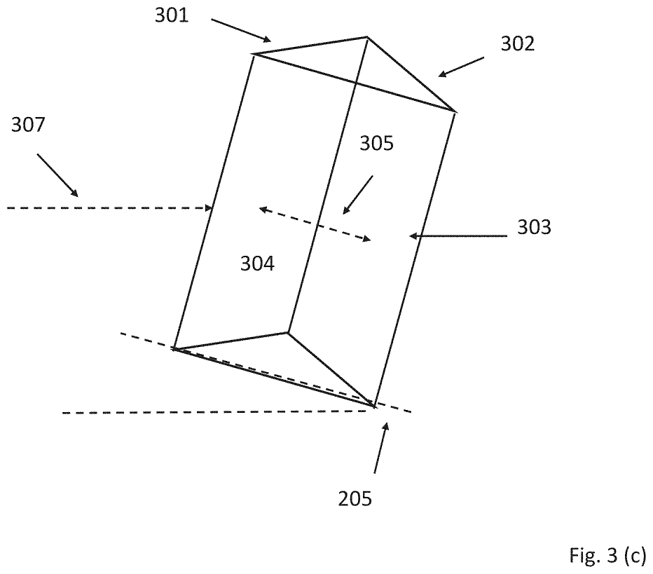

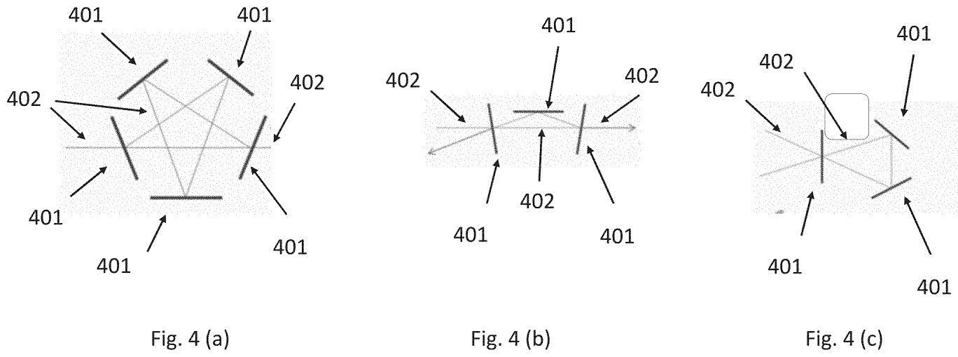

FIG. 3 (a) is a schematic diagram of an etalon 300 according to an embodiment. The etalon 300 includes three reflectors: a first partially reflecting surface 301, a second partially reflecting surface 302 and a fully reflecting surface 303. These three reflectors are arranged to form a cavity 304. In another embodiment, there is only one partially reflecting surface and two fully reflecting surfaces. The increase in the path length for the light beam within the cavity means that a reduction in size of the etalon 300 is possible for a given FSR. FIG. 3 (b) is a perspective view of an etalon 300 according to the embodiment of FIG. 3 (a). FIG. 3 (c) is a perspective view of an embodiment in which the etalon 300 is tilted, in a manner similar to the example of FIG. 2 (b). FIG. 4 (a), FIG. 4 (b) and FIG. 4 (c) are schematic illustrations of embodiments with odd numbers of reflectors. Each of these diagrams shows reflecting surfaces 401 and light paths 402.

With an odd number of reflections, however, the beam angle overlap depends on the input angle 306 of the incident beam, at 307. This can be seen from the pattern of reflections 305. Resonance will occur when the incident light 308 is at a specific angle. Although the embodiment of FIGS. 3 (a)-(c) achieves the aim of increasing the number of reflections with the cavity, the arrangement can be improved by providing an even number of reflectors, which can enable resonance without depending a on a specific angle of incidence.

In order to achieve an increased number of internal reflections and achieve resonance independently of the incident beam angle, two conditions are required: there are an even number of reflectors in the resonant path and/or the reflectors form opposing pairs of parallel planes. It can be shown that the resonator can consist of any number of pairs of opposing parallel reflectors.

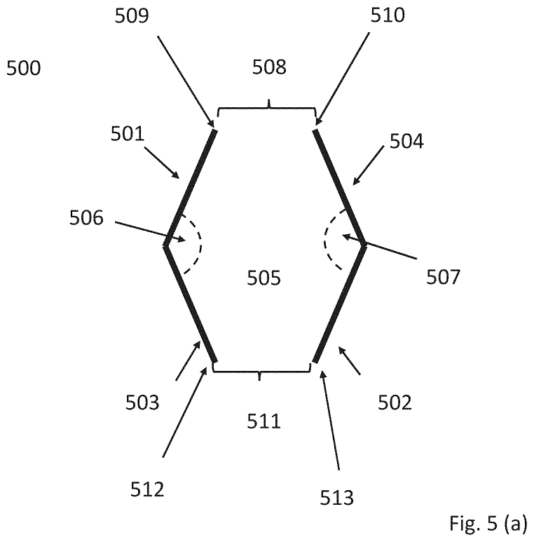

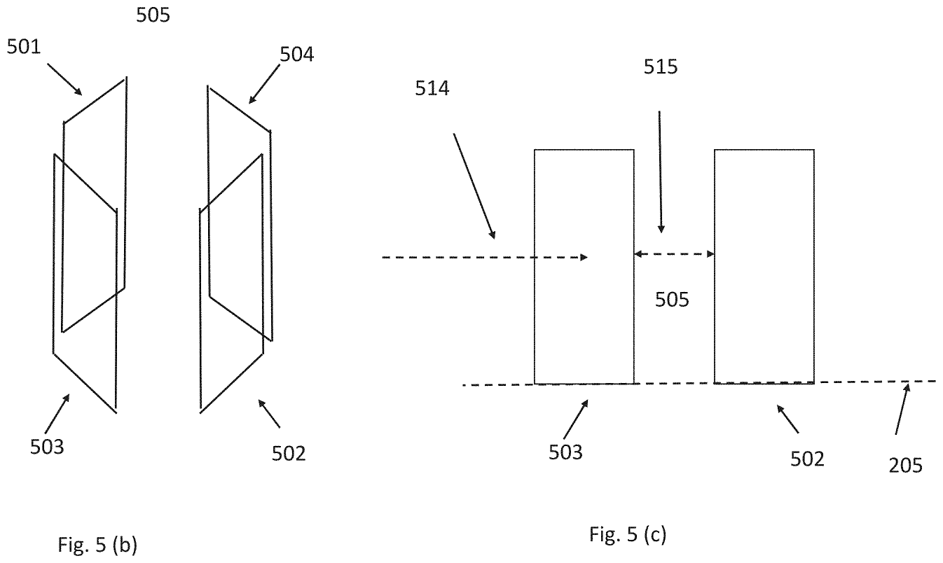

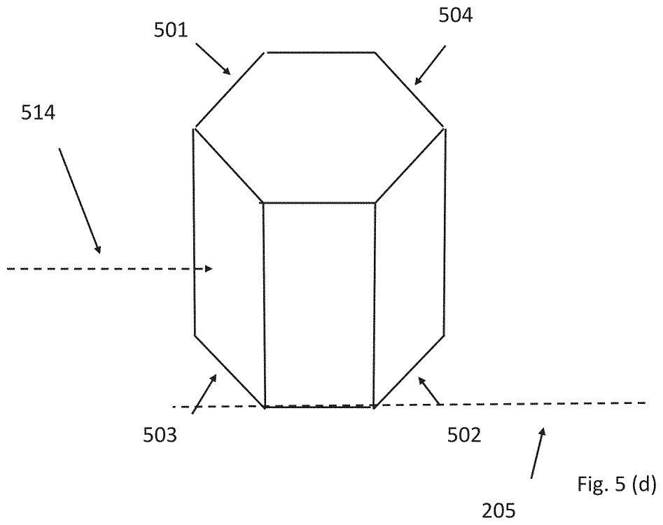

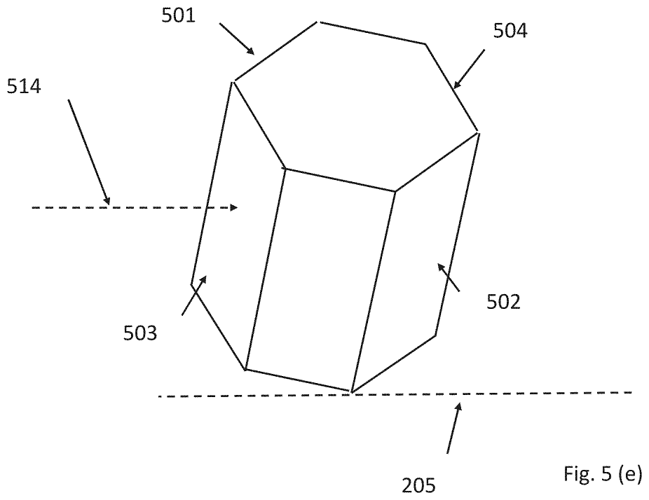

FIG. 5 (a) is a schematic view of an etalon 500 according to an embodiment. The etalon 500 includes 4 reflectors for transmitting and reflecting light, a first reflector 501, a second reflector 502, a third reflector 503, and a fourth reflector 504. In an embodiment, the reflectors are arranged so that the reflectors are perpendicular to the x-y plane and define a resonant cavity 505. Surfaces are arranged as two pairs of parallel reflectors, wherein the first pair of reflectors includes the first reflector 501 and the second reflector 502, and the second pair of reflectors includes the third reflector 503 and a fourth reflector 504. The first reflector 501 and the third reflector 503 are disposed adjacent each other and at an angle 506 to each other, and the second reflector 502 and fourth reflector 504 are disposed adjacent each other and at the angle 507 to each other. The angle 506 between the first reflector 501 and the third reflector 503, and the angle 507 between the second reflector 502 and the fourth reflector 504, are angles of the same value. In an embodiment, the angle may be an obtuse angle.

In an embodiment, there is a gap 508 between an edge 509 of the first reflector 501 and an edge 510 of the fourth reflector 504, the edges 509/510 being the vertical edges not adjacent to the third reflector 503 and the second reflector 502, respectively. A corresponding gap 511 of is disposed between an edge 512 of the third reflector 503 and an edge 513 of the second reflector 502, the edges 512/513 being the vertical edges not adjacent to the first reflector 501 and the fourth reflector 504, respectively. The length of the gaps 508, 511 can be determined by a light path length. In an embodiment, further surfaces may be provided in the gaps 508/511.

FIG. 5 (b) is a perspective diagram illustrating an etalon according to an embodiment, similar to that of the etalon of FIG. 5 (a). The diagram illustrates the four reflectors 501, 502, 503 and 504. FIG. 5 (c) is a side view of the embodiment of FIG. 5 (b), which illustrates two reflectors 503, 502, the incident light 514, the resonance within the cavity 515 and the conceptual plane 205. FIG. 5 (d) is a side view of an embodiment, with the same structure as that of FIG. 5 (c), but with the etalon implemented with a prism. FIG. 5 (e) is an etalon according to an embodiment with the same structure as that of FIG. 5 (d), but with the etalon tilted with respect to the incident light.

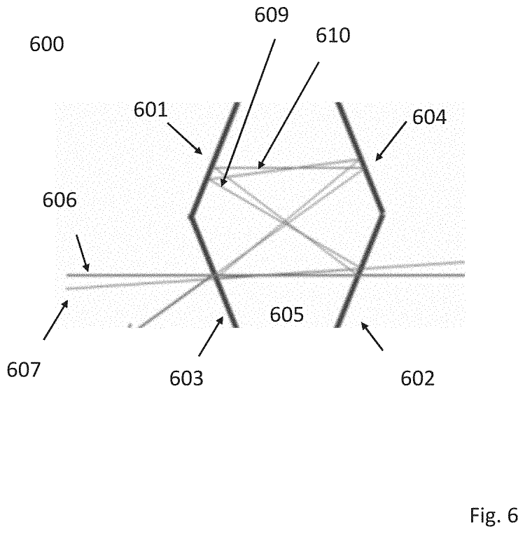

FIG. 6 is a schematic illustration of the embodiment 600 of FIG. 5 showing possible light paths through the resonant cavity of the etalon. As in FIG. 5, there is provided a first reflector 601, a second reflector 602, a third reflector 603, and a fourth reflector 604, defining a resonant cavity 605. Two possible paths 606, 607 for beams incident at different beam angles are shown, with corresponding multiple reflection paths 609, 610. It can be seen that both angles of incidence lead to resonance within the etalon, in contrast to the situation with only three reflectors. Additionally, angular variations of the input beam do not produce angular errors in the beam overlap between sequential reflections. Furthermore, shifting the beam position up and down produces no change in the output. This is the case, provided opposite reflectors are parallel. This advantage applies also to other embodiments which consist of multiple pairs of parallel reflectors.

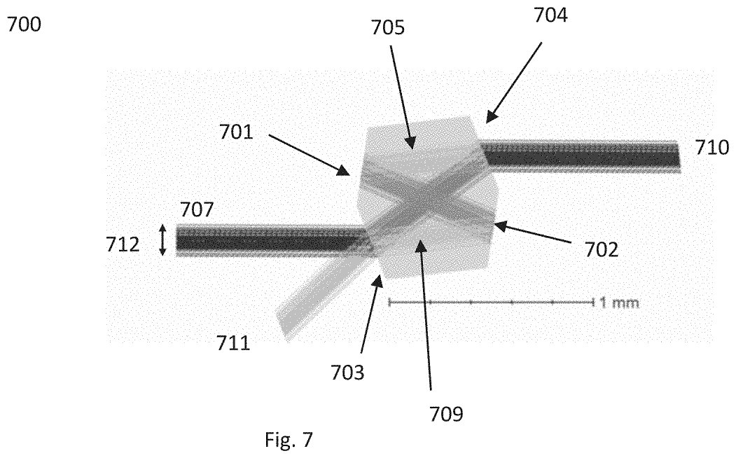

Etalons according to the invention may be implemented with mirrors, or alternatively with a prism. FIG. 7 is a schematic illustration of an etalon 700 implemented using a prism according to an embodiment. The etalon 700 has four reflectors 701, 702, 703, 704. In this embodiment these surfaces (the reflectors 701-704) are located on the sides of a prism 705. FIG. 7 illustrates incident beams 707, internal beams 709 within the prism 705 and exit beams 710, 711. FIG. 7 shows a number of rays constituting a single collimated beam, which is transmitted through the etalon. All partial beams 712 in this construction will have the same response by the etalon. Some other embodiments, such as those with odd numbers of reflectors, or the embodiments described below, such as the hexagonal, octagonal, and folded etalons may also be implemented with mirrors or a prism.

In some embodiments, the four reflectors 701-704 are coated so that etalon finesse is determined by the reflectivity of an input face at reflector 703 and an output face at reflector 704. The finesse of an etalon is the ratio of the free spectral range and the full width at half maximum of a resonance for a specific resonance wavelength. Reflectivities are in a range of 10% to 99% reflectivity at 1550 nm. In some embodiments, the other reflectors 701, 702 are coated to give 100% reflection.

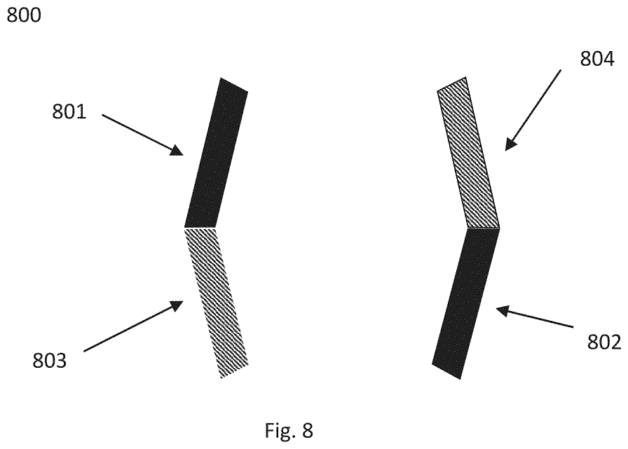

Different options are available for the location of the partially and fully reflecting surfaces. FIG. 8 is a schematic diagram which illustrates the arrangement for the embodiment of FIG. 7. The etalon 800 of FIG. 8 has a first reflector 801, a second reflector 802, a third reflector 803, and a fourth reflector 804. In this embodiment, the first reflector 801 and the second reflector 802 are fully reflecting surfaces, and the fourth reflector 804 and the third reflector 803 are partially reflecting surfaces, providing input and output faces.

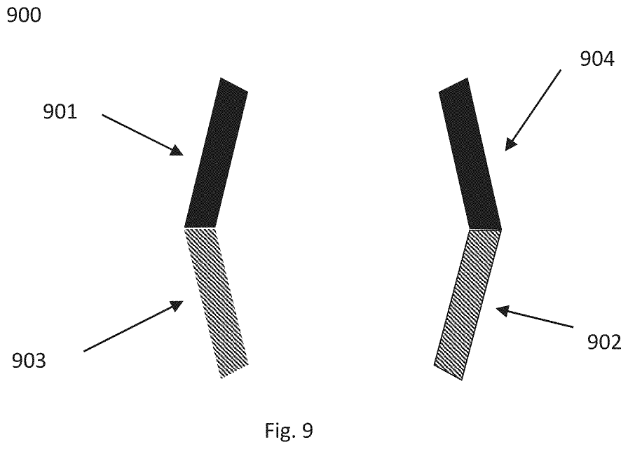

FIG. 9 is a schematic diagram which illustrates an alternative arrangement for the partially and fully reflecting surfaces. As in previous embodiments, the etalon 900 of FIG. 9 has a first reflector 901, a second reflector 902, a third reflector 903, and a fourth reflector 904. In this embodiment, the first reflector 901 and the fourth reflector 904 are fully reflecting surfaces, and the third reflector 903 and the second reflector 902 are partially reflecting surfaces, providing input and output faces. This provides for a different position of the output face compared with the embodiment of FIG. 8.

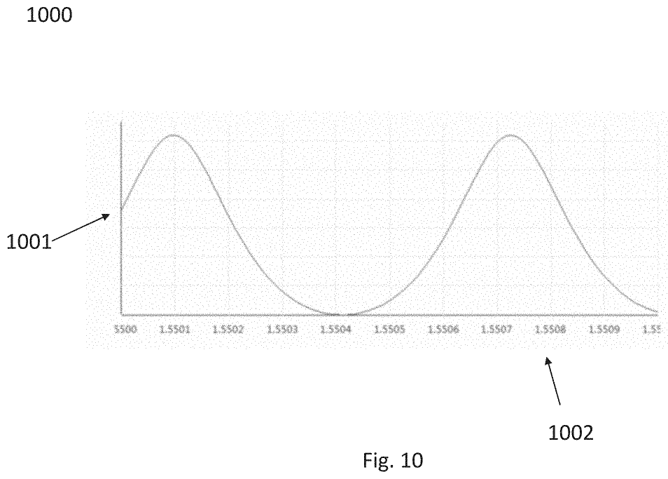

FIG. 10 is a graph 1000 showing simulation results obtained for power transmission 1001 against wavelength 1002 for an etalon 700 according to the embodiment of FIG. 7.

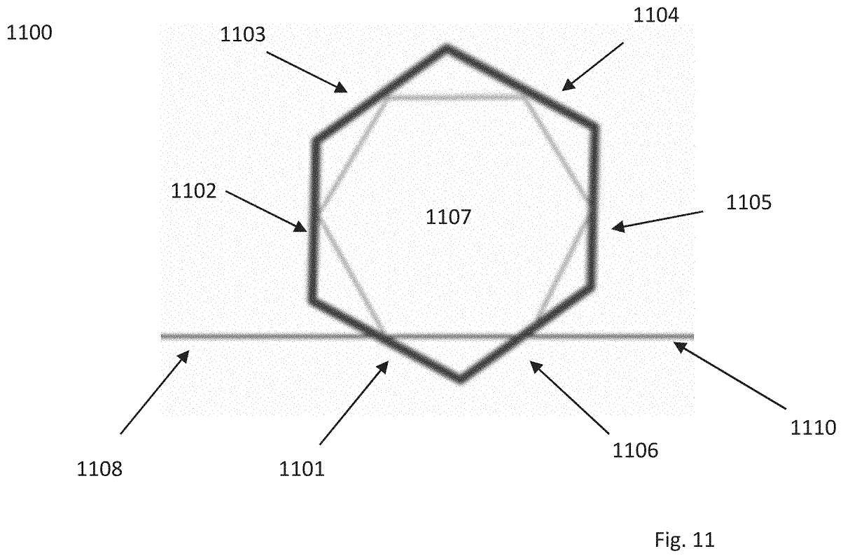

FIG. 11 is a schematic diagram of an etalon, according to an embodiment 1100, in which there is provided six reflectors. The reflectors are arranged in a hexagonal arrangement. The reflectors include a first reflector 1101, a second reflector 1102, a third reflector 1103, a fourth reflector 1104, a fifth reflector 1105 and a sixth reflector 1106, forming a resonant cavity 1107. The first reflector 1101 and the fourth reflector 1104, the second reflector 1102 and the fifth reflector 1105, and the third reflector 1103 and the sixth reflector 1106 form three respective pairs of parallel reflectors, thus enabling resonance independent of incident angle (e.g., which occurs when having a plurality of pairs of parallel reflectors). As with previous embodiments, the reflectors 1101-1106 are disposed perpendicular to the x-y plane, and the arrangement may be implemented using a prism or with mirrors.

In FIG. 11, the first reflector 1101 and the sixth reflector 1106 are partially reflecting surfaces, and the second reflector 1102, the third reflector 1103, the fourth reflector 1104, and the fifth reflector 1105 are fully reflecting surfaces. In operation, an input beam 1108 is incident on the first reflector 1101, enters the resonant cavity 1107 and exits through the sixth reflector 1106 at 1110. However, other combinations of fully and partially reflecting surfaces are possible, and the invention is not limited to any one combination. In an embodiment, only one reflector is a partially reflecting surface, acting as both input face and output face, with the other reflectors being fully reflecting.

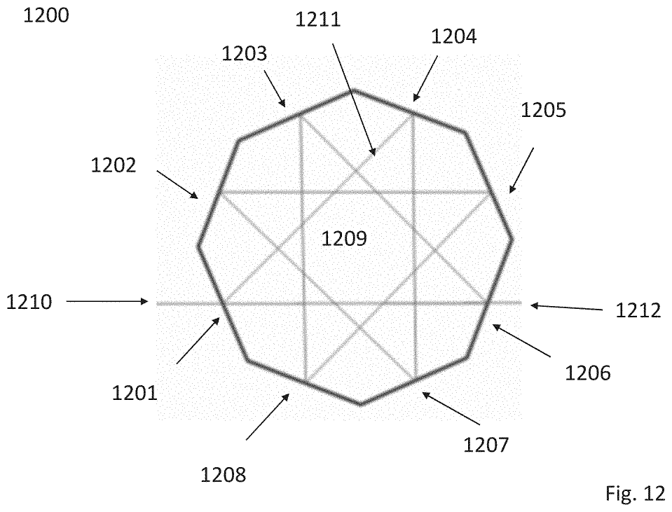

FIG. 12 is a schematic diagram of an etalon 1200, according to an embodiment, in which there is provided eight reflectors. The reflectors of etalon 1200 are arranged in in a hexagonal arrangement (e.g., forming a hexagonal prism). Alternatively, in another embodiment, reflectors may be arranged to form a regular polygon with 2n sides (e.g., where n is an integer greater than or equal to 1). Etalon 1200 includes a first reflector 1201, a second reflector 1202, a third reflector 1203, a fourth reflector 1204, a fifth reflector 1205, a sixth reflector 1206, a seventh reflector 1207, and an eighth reflector 1208, forming a resonant cavity 1209. The first reflector 1201 and the fifth reflector 1205, the second reflector 1202 and the sixth reflector 1206, the third reflector 1203 and the seventh reflector 1207, and the fourth reflector 1204 and the eighth reflector 1208 form four respective pairs of parallel reflectors, thereby enabling resonance independent of incident angle. In some embodiments, the reflectors 1201-1208 are disposed perpendicular to the x-y plane, and the arrangement may be implemented using a prism or with mirrors.

In FIG. 12, the first reflector 1201 and the sixth reflector 1206 are partially reflecting surfaces, and the second reflector 1202, the third reflector 1203, the fourth reflector 1204, the fifth reflector 1205, the seventh reflector 1207 and the eighth reflector 1208 are fully reflecting surfaces. In operation, an input beam 1210 is incident on the first reflector, enters the resonant cavity 1209, reflects at 1211 within the cavity and exits through the sixth reflector 1206 at 1212. However, other combinations of fully and partially reflecting surfaces are possible, and the invention is not limited to any one combination. In an embodiment, only one reflector is a partially reflecting surface, acting as both input face and output face, with the other reflectors being fully reflecting.

In other embodiments, any number of pairs of parallel reflectors can be used. As with previous embodiments, such arrangements may be implemented using mirrors or prisms. Any of the features described above, such as the arrangements of partially reflecting and fully reflecting surfaces may be used, the embodiments differing only in the number of pairs of reflectors.

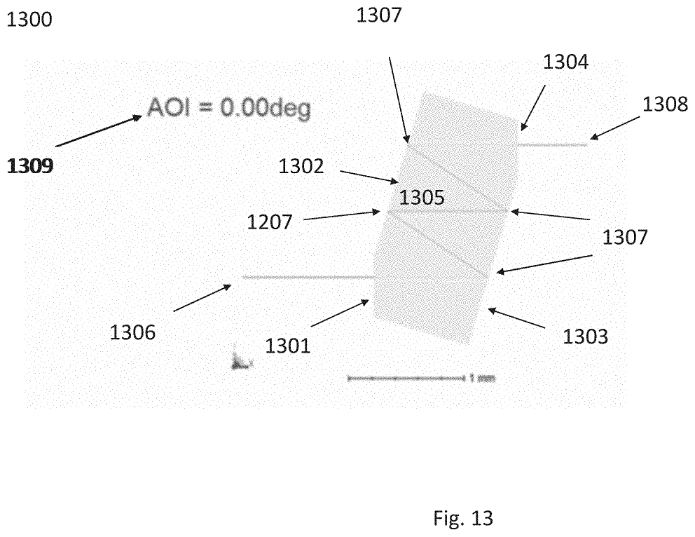

FIG. 13 is a schematic diagram of an embodiment, in which four reflectors are provided, in a configuration that may be referred to as a “folded beam etalon.” The etalon consists of four reflectors, a first reflector 1301, a second reflector 1302, a third reflector 1303, and a fourth reflector 1304, forming a resonant cavity 1305. The first reflector 1301 and the fourth reflector 1304 form a first parallel pair, and the second reflector 1302 and the third reflector 1303 form a second parallel pair. The first reflector 1301 and the fourth reflector 1304 have a first length, and the second reflector 1302 and the third reflector 1303 have a second length. The second length is longer than the first length. The first reflector 1301 and the fourth reflector 1304 act as input and output faces respectively. The longer second and third reflectors 1302/1303 allow multiple reflections with the resonant cavity 1305. The second length is configured so as to allow multiple reflections in the resonant cavity 1305. In operation, an incident beam 1306 enters the etalon 1300. In FIG. 13, this is shown as being incident perpendicularly to the first reflector 1301, with an angle of incidence 1309 of 0°. However, as with other embodiments with pairs of parallel reflectors, other incident angles within around +/−5° of normal are possible and the invention is not limited to any one angle of incidence. The beam reflects at 1307 within the resonant cavity and exits at 1308 via the fourth reflector 1304.

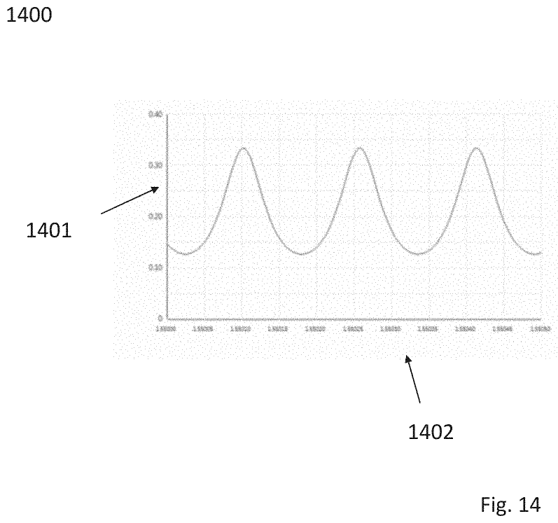

Using the structure of FIG. 13, the FSR for a 1 mm width etalon is 37 GHz, an approximate ratio of 3:1 ratio compared with other etalon designs (e.g., which may have an FSR, for a 1 mm etalon, of approximately 100 GHz). FIG. 14 is a graph 1400 showing results obtained for a modeled response for power transmission 1401 against wavelength 1402 for an etalon according to an embodiment described herein. The results shown are for a narrowly defined set of optical rays through the etalon shown in FIG. 13 with an angle of incidence 0° (normal incidence).

Further reductions in the FSR are possible by increasing the number of reflections before the beam reaches the output face. This may be achieved by either increasing the length of the etalon (e.g., increasing the second length of the second and third reflectors) or bringing the internally reflected angle closer to normal incidence. In the embodiment of FIG. 13, there is a limit on the amount by which changing the internally reflected angle can be achieved, since internally, the beam widths are configured to not overlap.

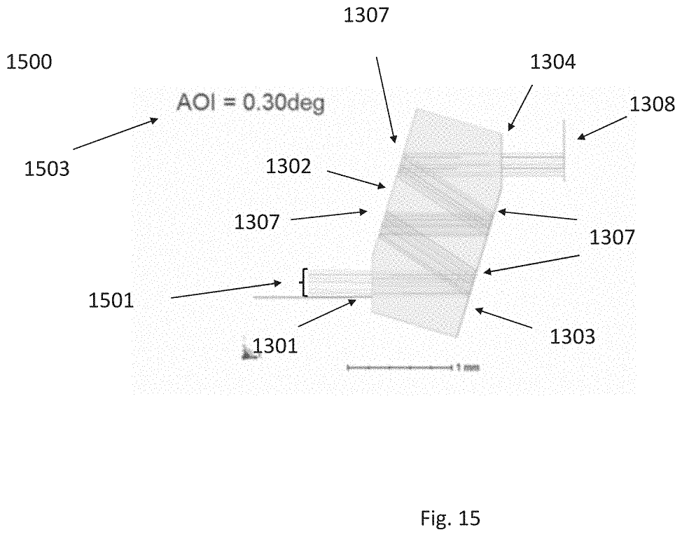

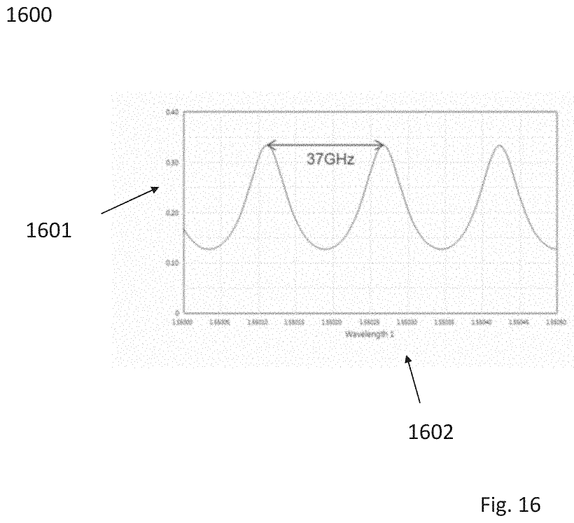

FIG. 15 is a schematic diagram of the embodiment of FIG. 13, with similar components, illustrating multiple beams or simulation rays comprising a single beam 1501 incident on an etalon 1500. Here the angle of incidence 1503 is 0.3°. FIG. 16 is a graph 1600 showing results obtained for a modeled response for power transmission 1601 against wavelength 1602 for an etalon according to some embodiments described herein. FIG. 16 shows a very similar response to that of FIG. 14, but in FIG. 16, the response is for a set of rays representing a relatively wide beam through the etalon 1500 as shown in FIG. 15 with a small angle of incidence of 0.3 degrees. A difference in these two plots is a small difference in absolute wavelength positioning and a small change in peak wavelength separation (e.g., free spectral range). These differences are based on the small angle of incidence change (e.g., rather than the beam width).

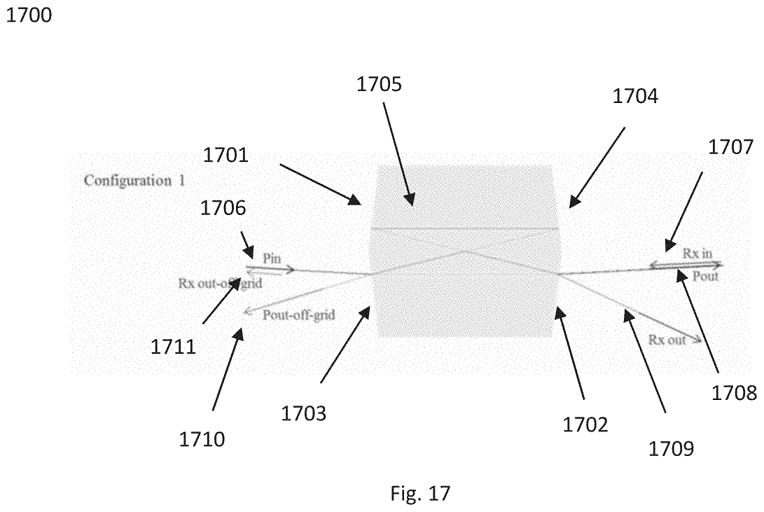

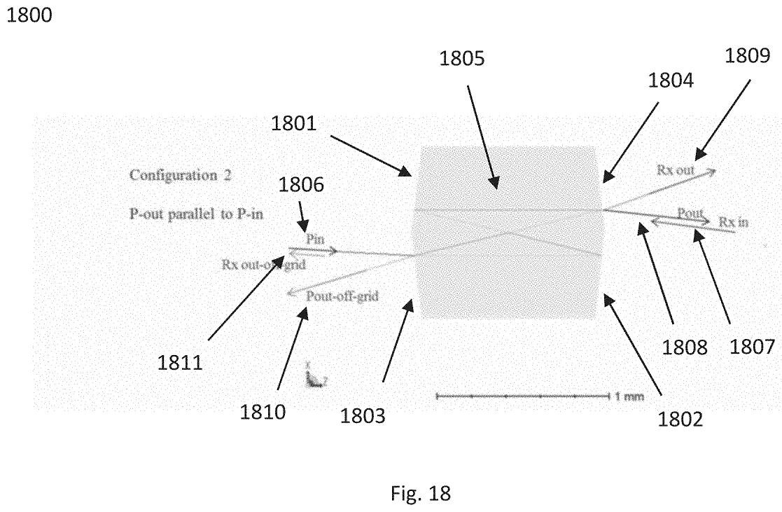

A cross-over etalon, according to embodiments of the present invention, may be used as an interleaver or bidirectional filter, among other examples. These applications utilize the property of embodiments of the present invention in which the beam reflected back into the source and does not follow the path of the incident beam, but is reflected back at a large angle. For these applications, a four reflector configuration may be used. However, other configurations may also be suitable. For these cases, optical alignment conditions (e.g., beam overlap independence of input angle and independence of beam position within the etalon) apply to an etalon described herein. There are two configurations for the etalon shown in FIGS. 17 and 18 respectively. In configuration 1 (FIG. 17), the output beam is not parallel to the input beam and the partial reflectors are at adjacent positions and the full mirrors are at the top. In configuration 2 (FIG. 18), the partial and full mirrors alternate and the output beam is parallel to the input beam.

FIG. 17 is a schematic diagram of an etalon 1700 with configuration 1, according to an embodiment. The etalon 1700 may, as in previous embodiments, be implemented with mirrors or a prism. Etalon 1700 includes a first reflector 1701, a second reflector 1702, a third reflector 1703, and a fourth reflector 1704, forming a resonant cavity 1705. The first reflector 1701 and the fourth reflector 1704 are fully reflecting surfaces. The second reflector 1702 and the third reflector 1703 are partially reflecting surfaces. There are two input beams, the input beam Pᵢₙ 1706 and a received beam Rxᵢₙ 1707. There are two outputs, Pₒᵤₜ 1708, Rxₒᵤₜ 1709, and two back reflected beams, deflected from the main optical path of the input and received beams. The two back reflected beams include a back reflected beam of the input 1710 and a back reflected beam of the received beam 1711.

FIG. 18 is a schematic diagram of an etalon 1800 with configuration 2, according to an embodiment. The etalon 1800 may, as in previous embodiments, be implemented with mirrors or a prism. The etalon 1800 includes a first reflector 1801, a second reflector 1802, a third reflector 1803, and a fourth reflector 1804, forming a resonant cavity 1805. The arrangement differs from that of FIG. 17, in that the first reflector 1801 and the second reflector 1802 are fully reflecting surfaces, and the third reflector 1803 and the fourth reflector 1804 are partially reflecting surfaces. There are two input beams, the input beam Pᵢₙ 1806 and a received beam Rxᵢₙ 1807. There are two outputs, Pout 1808, Rxₒᵤₜ 1809, and two back reflected beams (deflected from the main optical path of the input and received beams) (e.g., a back reflected beam of the input 1810 and a back reflected beam of the received beam 1811).

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An etalon, comprising:
a plurality of reflectors,
wherein at least one reflector, of the plurality of reflectors, is partially reflecting of light in a frequency range and each other reflector, of the plurality of reflectors is either partially or fully reflecting of light in the frequency range, and
wherein the plurality of reflectors comprises at least three reflectors arranged to define a volume of a resonant optical cavity.

2. The etalon of claim 1, wherein the plurality of reflectors consists a plurality of pairs of parallel reflectors.

3. The etalon of claim 2, wherein the plurality of pairs of parallel reflectors comprises:
a first pair of parallel reflectors and a second pair of parallel reflectors,
wherein the first pair of reflectors includes a first reflector and a second reflector,
wherein the second pair of reflectors includes a third reflector and a fourth reflector,
wherein the first reflector and the third reflector are disposed adjacent to each other and at an angle to each other and the second reflector and fourth reflector are disposed adjacent to each other and at the angle to each other.

4. The etalon of claim 3, wherein the etalon comprises a hexagonal prism, and
wherein the first reflector, the second reflector, the third reflector, and the fourth reflector are disposed on sides of the hexagonal prism, and
wherein the hexagonal prism further comprises a fifth reflector and a sixth reflector,
wherein the fifth reflector is disposed on a side of the hexagonal prism between the first reflector and the fourth reflector and the sixth reflector is disposed between the third reflector and the second reflector.

5. The etalon of claim 3, wherein each reflector, of the plurality of reflectors, has a respective first edge and a respective second edge parallel to the respective first edge,
respective first edges of the first reflector and the third reflector being adjacent each other and respective first edges of the second reflector and the fourth reflector being adjacent each other,
wherein the etalon further comprises:
a first gap between a second edge of the first reflector and a second edge of the fourth reflector, and
a second gap between a second edge of the second reflector and a second edge of the third reflector,
wherein lengths of the first gap and the second gap are based on a light path length.

6. The etalon of claim 5, wherein a fifth reflector is disposed in the first gap and a sixth reflector is disposed in the second gap.

7. The etalon of claim 3, wherein the first reflector and the second reflector are of a first length and the third reflector and the fourth reflector are of a second length,
the first length being longer than the second length,
the first length being configured to enable a plurality of reflections between the first reflector and the second reflector for light incident perpendicular to the third reflector.

8. The etalon of claim 3, wherein the third reflector is partially reflecting and the first reflector, the second reflector, and the fourth reflector are fully reflecting.

9. The etalon of claim 3, wherein the third reflector and the fourth reflector are partially reflecting and the first reflector and the second reflector are fully reflecting.

10. The etalon of claim 3, wherein the second reflector and the third reflector are partially reflecting and the first reflector and the fourth reflector are fully reflecting.

11. The etalon of claim 2, wherein the plurality of pairs of parallel reflectors is arranged to define a regular polygon with 2n sides, wherein n is an integer greater than 1.

12. The etalon of claim 1, wherein one reflector, of the plurality of reflectors, is partially reflecting and each of the other reflectors, of the plurality of reflectors, is fully reflecting.

13. The etalon of claim 1, wherein two reflectors, of the plurality of reflectors, are partially reflecting and each of the other reflectors, of the plurality of reflectors, is fully reflecting.

14. The etalon of claim 1, wherein one or more partially reflecting surfaces, of the plurality of reflectors, has a reflectivity in a range of 10% to 99% at 1550 nanometers (nm).

15. A bidirectional filter, comprising:
An etalon, wherein the etalon comprises:
a plurality of reflectors,
wherein at least one reflector, of the plurality of reflectors, is partially reflecting of light in a frequency range and each other reflector, of the plurality of reflectors is either partially or fully reflecting of light in the frequency range, and
wherein the plurality of reflectors comprises at least three reflectors arranged to define a volume of a resonant optical cavity.

16. The bidirectional filter of claim 15, wherein the etalon is a solid etalon.

17. The bidirectional filter of claim 15, wherein the etalon is an air gap etalon.

18. The bidirectional filter of claim 15, wherein the plurality of reflectors is arranged perpendicular to an x-y plane, and is arranged to form a resonant optical cavity for light transmitted in the x-y plane.

19. The bidirectional filter of claim 15, wherein the plurality of reflectors is tilted at an angle to a direction of incident light.

20. An etalon, comprising:
a plurality of reflectors,
wherein a first set of reflectors, of the plurality of reflectors, is partially reflecting of light in a frequency range and a second set of reflectors, of the plurality of reflectors is fully reflecting of light in the frequency range, and
wherein the plurality of reflectors comprises an even quantity of reflectors arranged to define a volume of a resonant optical cavity.
